(19) United States
(12) Patent Application Publication
(10) Pub. No.: US 2026/0343369 A1
(43) Pub. Date: Oct. 29, 2026

(54) CONFIGURING LINKING BETWEEN MOBILITY CONFIGURATIONS

(71) Applicant: Lenovo (Singapore) Pte. Ltd., Singapore (SG)

(72) Inventors: Prateek Basu Mallick, Dreieich (DE); Joachim Löhr, Wiesbaden (DE); Karthikeyan Ganesan, Nauheim (DE); Alexander Golitschek Edler von Elbwart, Darmstadt (DE); Ravi Kuchibhotla, Chicago, IL (US)

(21) Appl. No.: 19/111,695

(22) PCT Filed: Sep. 29, 2023
(86) PCT No.: PCT/IB2023/059805

§ 371 Date: Mar. 13, 2025

Related U.S. Application Data
(60) Provisional application No. 63/411,273, filed on Sep. 29, 2022.

(51) Int. Cl. H04W 36/32; H04W 36/00

(52) U.S. Cl. CPC H04W 36/324; H04W 36/0069; H04W 36/0085

(57) ABSTRACT

OF THE DISCLOSURE Apparatuses, methods, and systems are disclosed for configuring linking between mobility configurations. One method (1000) includes receiving (1002), at a user equipment (“UE”), at least one mobility configuration. The at least one mobility configuration includes linking information. The method (1000) includes performing (1004) a measurement on a first active configuration of the at least one mobility Receive At Least One Mobility Configuration, Wherein configuration. The method (1000) includes determining (1006) a target configuration based on the measurement. The method (1000) includes activating (1008) a linked mobility configuration of the at least one mobility configuration. The linked mobility configuration is linked to the target configuration based on the linking information.

### FIELD

The subject matter disclosed herein relates generally to wireless communications and more particularly relates to configuring linking between mobility configurations.

### BACKGROUND

In certain wireless communications systems, devices may move between cells. In such systems, changes in configurations may need to be made.

### BRIEF SUMMARY

Methods for configuring linking between mobility configurations are disclosed. Apparatuses and systems also perform the functions of the methods. One embodiment of a method includes receiving, at a user equipment (“UE”), at least one mobility configuration. The at least one mobility configuration includes linking information. In some embodiments, the method includes performing a measurement on a first active configuration of the at least one mobility configuration. In certain embodiments, the method includes determining a target configuration based on the measurement. In various embodiments, the method includes activating a linked mobility configuration of the at least one mobility configuration. The linked mobility configuration is linked to the target configuration based on the linking information.

One apparatus for configuring linking between mobility configurations includes a processor. In some embodiments, the apparatus includes a memory coupled to the processor, the processor configured to cause the apparatus to: receive at least one mobility configuration, wherein the at least one mobility configuration includes linking information; perform a measurement on a first active configuration of the at least one mobility configuration; determine a target configuration based on the measurement; and activate a linked mobility configuration of the at least one mobility configuration. The linked mobility configuration is linked to the target configuration based on the linking information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring linking between mobility configurations;

FIG. 2 is a schematic block diagram illustrating one embodiment of an apparatus that may be used for configuring linking between mobility configurations;

FIG. 3 is a schematic block diagram illustrating one embodiment of an apparatus that may be used for configuring linking between mobility configurations;

FIG. 4 is a schematic block diagram illustrating one embodiment of a system for inter-gNB handover (“HO”) procedures;

FIG. 5 is a schematic block diagram illustrating one embodiment of a system for intra-access and mobility management function (“AMF”) and/or user plane function (“UPF”) HO;

FIG. 6 is a block diagram illustrating one embodiment of a system having dual connectivity;

FIGS. 7A through 7C are diagram illustrating one embodiment of code for an RRC reconfiguration message;

FIG. 8 is a schematic block diagram illustrating one embodiment of a system showing three candidate configurations provided to a UE;

FIG. 9 is a schematic block diagram illustrating one embodiment of a system showing candidate configuration activation; and

FIG. 10 is a flow chart diagram illustrating one embodiment of a method for configuring linking between mobility configurations.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

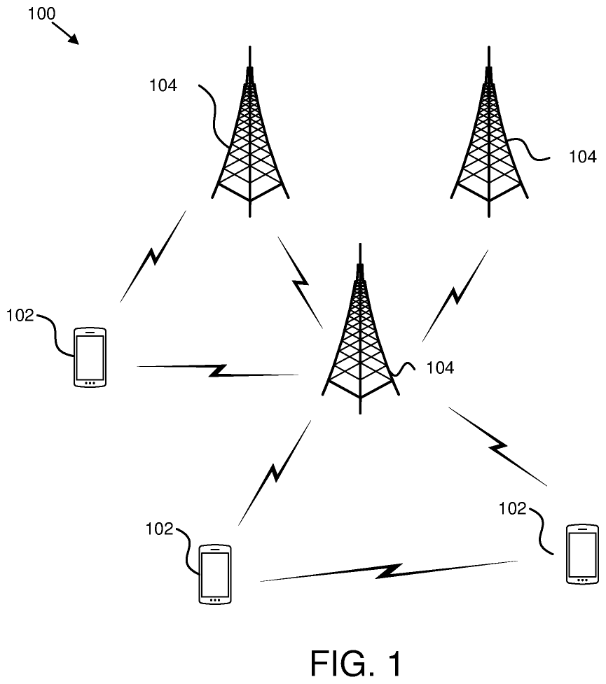

FIG. 1 depicts an embodiment of a wireless communication system 100 for configuring linking between mobility configurations. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an AMF, a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a UPF, an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an orthogonal frequency division multiplexing (“OFDM”) modulation scheme on the downlink (“DL”) and the remote units 102 transmit on the uplink (“UL”) using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive at least one mobility configuration. The at least one mobility configuration includes linking information. In some embodiments, the remote unit 102 may perform a measurement on a first active configuration of the at least one mobility configuration. In certain embodiments, the remote unit 102 may determine a target configuration based on the measurement. In various embodiments, the remote unit 102 may activate a linked mobility configuration of the at least one mobility configuration. The linked mobility configuration is linked to the target configuration based on the linking information. Accordingly, the remote unit 102 may be used for configuring linking between mobility configurations.

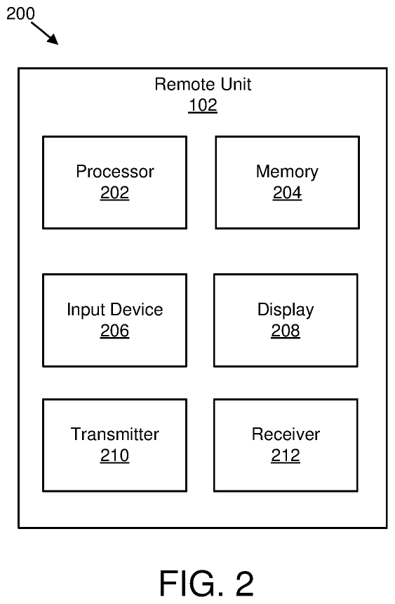

FIG. 2 depicts one embodiment of an apparatus 200 that may be used for configuring linking between mobility configurations. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 is configured to cause the apparatus to: receive at least one mobility configuration, wherein the at least one mobility configuration includes linking information; perform a measurement on a first active configuration of the at least one mobility configuration; determine a target configuration based on the measurement; and activate a linked mobility configuration of the at least one mobility configuration. The linked mobility configuration is linked to the target configuration based on the linking information.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

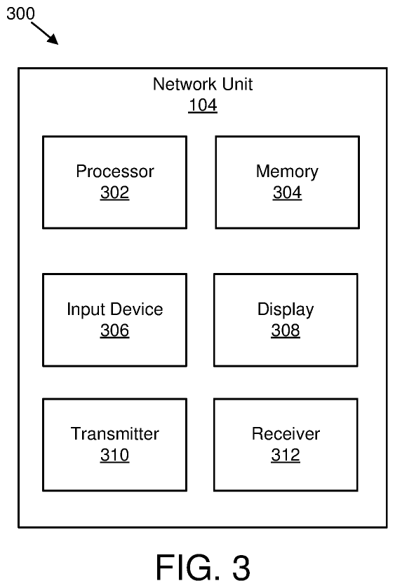

FIG. 3 depicts one embodiment of an apparatus 300 that may be used for configuring linking between mobility configurations. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

It should be noted that one or more embodiments described herein may be combined into a single embodiment.

In certain embodiments, when a UE moves from a coverage area of one cell to another cell, at some point a serving cell change needs to be made since a current serving cell does not remain a viable radio option. The serving cell change may be triggered by layer 3 (“L3”) measurements and may be done by a radio resource control (“RRC”) signaling triggered reconfiguration with synchronization for a change of a primary cell (“PCell”) and a primary secondary cell (“PSCell”). In some embodiments, there may be a release of SCells. In various embodiments, there may be complete layer 2 (“L2”) and/or layer 1 (“L1”) resets which may lead to longer latency, larger overhead, and longer interruption time than beam switch mobility. In certain embodiments, L1 and/or L2 mobility enhancements may enable a serving cell change via L1 and/or L2 signaling to reduce latency, overhead, and/or interruption time.

In various embodiments, a conditional PSCell change (“CPC”) and/or conditional PSCell addition (“CPA”) (“CPC/CPA”). A CPC/CPA-configured UE may release the CPC/CPA configurations if completing random access with transmissions towards a target PSCell. In such conditions, a UE may not have a chance to perform subsequent CPC/CPA without prior CPC/CPA reconfiguration and reinitialization instructions from a network. This may increase the delay for the cell change and increase signaling overhead (e.g., for frequent secondary cell group (“SCG”) changes in a frequency range 2 (“FR2”)). Therefore, multi radio access technology (“RAT”) (“MR”) dual connectivity (“DC”) (“MR-DC”) with selective activation of cell groups may enable subsequent CPC/CPA after a SCG change without reconfiguration and reinitialization on the CPC/CPA from the network. This may result in a reduction of signaling overhead and interrupting time for the SCG change.

In certain embodiments, conditional HO (“CHO”) and MR-DC cannot be configured simultaneously. This may limit the usefulness of these two features when MR-DC is configured. In some embodiments, CHO and MR-DC may be configured simultaneously. In various embodiments, CHO+MR-DC may consider CHO including target master cell group (“MCG”) and multiple candidate SCGs for CPC/CPA.

In some embodiments, RRC connected mobility may be defined.

Network controlled mobility may apply to UEs in an RRC_CONNECTED state and may be categorized into two types of mobility: cell level mobility and beam level mobility. Beam level mobility includes intra-cell beam level mobility and inter-cell beam level mobility.

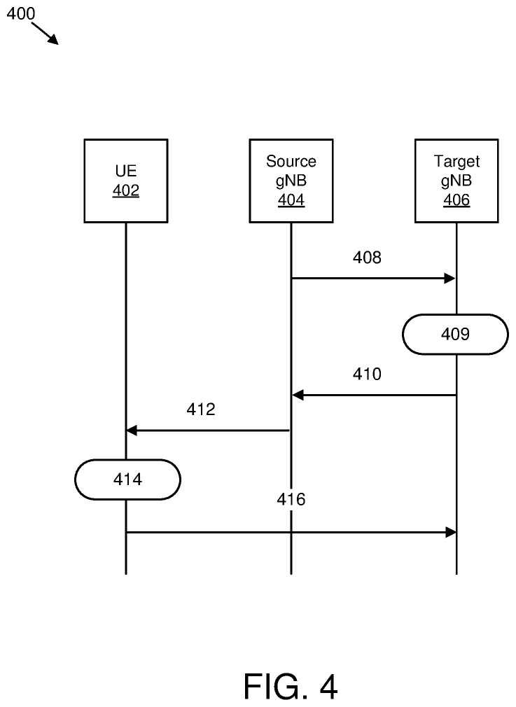

Cell level mobility may use explicit RRC signaling to be triggered (e.g., HO). For inter-gNB HO, signaling procedures include at least the elemental components illustrated in FIG. 4.

FIG. 4 is a schematic block diagram illustrating one embodiment of a system 400 for inter-gNB HO procedures. The system 400 includes a UE 402, a source gNB 404, and a target gNB 406. Each of the communications in the system 400 may include one or more messages.

In a first communication 408, the source gNB 404 initiates HO and issues a HANDOVER REQUEST over an Xn interface.

The target gNB 406 performs 409 admission control and, in a second communication 410, provides a new RRC configuration as part of a HANDOVER REQUEST ACKNOWLEDGE.

In a third communication 412, the source gNB 404 provides the RRC configuration to the UE 402 by forwarding the RRCReconfiguration message received in the HANDOVER REQUEST ACKNOWLEDGE. The RRCReconfiguration message includes at least a cell ID and all information required to access the target cell so that the UE 402 can access the target cell without reading system information. For some cases, the information required for contention-based and contention-free random access can be included in the RRCReconfiguration message. The access information to the target cell may include beam specific information, if any.

The UE 402 moves 414 the RRC connection to the target gNB 406 and, in a fourth communication 416, replies with a RRCReconfigurationComplete message. In some embodiments, user data may be sent in the fourth communication 416 if a grant allows this.

For dual active protocol stack (“DAPS”) HO, the UE continues the downlink user data reception from the source gNB until releasing the source cell and continues the uplink user data transmission to the source gNB until successful random access procedure to the target gNB.

Only source and target PCell are used during DAPS HO. Carrier aggregation (“CA”), DC, supplementary uplink (“SUL”), multiple transmission and reception point (“TRP”) (“multi-TRP”), EHC, CHO, UDC, NR sidelink configurations and vehicle to everything (“V2X”) sidelink configurations are released by the source gNB before the HO command is sent to the UE and are not configured by the target gNB until the DAPS HO has completed (e.g., at earliest in the same message that releases the source PCell).

The HO mechanism triggered by RRC requires the UE at least to reset the medium access control (“MAC”) entity and re-establish a radio link connection (“RLC”), except for DAPS HO, where upon reception of the HO command, the UE: 1) creates a MAC entity for target; 2) establishes the RLC entity and an associated dedicated traffic channel (“DTCH”) logical channel for a target for each data radio bearer (“DRB”) configured with DAPS; 3) for each DRB configured with DAPS, reconfigures a packet data convergence protocol (“PDCP”) entity with separate security and robust header compression (“ROHC”) functions for a source and a target and associates them with the RLC entities configured by the source and the target, respectively; and 4) retains the rest of the source configurations until there is a release of the source.

RRC managed HOs with and without PDCP entity re-establishment may both be supported. For DRBs using an RLC acknowledge mode (“AM”) mode, PDCP can either be re-established together with a security key change or may initiate a data recovery procedure without a key change. For DRBs using an RLC unacknowledged mode (“UM”) mode, PDCP can either be re-established together with a security key change or remain as it is without a key change. For a signaling radio bearer (“SRBs”), PDCP may either remain as it is and discard its stored PDCP protocol data units (“PDUs”) and/or service data units (“SDUs”) without a key change or be re-established together with a security key change.

In various embodiments, data forwarding, in-sequence delivery, and duplication avoidance at HO can be guaranteed if the target gNB uses the same DRB configuration as the source gNB.

A timer based HO failure procedure may be supported in NR. Moreover, an RRC connection re-establishment procedure may be used for recovering from HO failure except in certain CHO or DAPS HO scenarios: 1) when DAPS HO fails, the UE falls back to the source cell configuration, resumes the connection with the source cell, and reports DAPS HO failure via the source without triggering RRC connection re-establishment if the source link has not been released; and 2) when initial CHO execution attempt fails or HO overview fails, the UE performs cell selection, and if the selected cell is a CHO candidate and if the network configured the UE to try CHO after HO and/or CHO failure, then the UE attempts CHO execution once, otherwise re-establishment is performed. DAPS HO for FR2 to FR2 may not be supported.

The HO of an integrated access and backhaul (“IAB”) mobile termination (“MT”) (“IAB-MT”) in a standalone (“SA”) mode may follow the same procedure as described for a UE. After a backhaul has been established, the HO of the IAB-MT may be part of an intra central unit (“CU”) (“intra-CU”) topology adaptation procedure. Modifications to the configuration of a backhaul adaptation protocol (“BAP”) sublayer and higher protocol layers above the BAP sublayer may be made.

Beam level mobility does not require explicit RRC signaling to be triggered. Beam level mobility may be within a cell or between cells, the latter is referred to as inter-cell beam management (“ICBM”). For ICBM, a UE can receive or transmit UE dedicated channels and/or signals via a TRP associated with a physical cell identifier (“ID”) (“PCI”) different from the PCI of a serving cell, while non-UE-dedicated channels and/or signals may only be received via a TRP associated with a PCI of the serving cell. The gNB provides, via RRC signaling, the UE with a measurement configuration containing configurations of synchronization signal block (“SSB”) and/or channel state information (“CSI”) resources and resource sets, and reports and trigger states for triggering channel and interference measurements and reports. For ICBM, a measurement configuration includes SSB resources associated with PCIs different from the PCI of a serving cell. Beam level mobility is then dealt with at lower layers by means of physical layer and MAC layer control signaling, and RRC is not required to know which beam is being used at a given point in time.

SSB-based beam level mobility may be based on an SSB associated with an initial downlink (“DL”) bandwidth part (“BWP”) and may only be configured for the initial DL BWPs and for DL BWPs containing the SSB associated with the initial DL BWP. For other DL BWPs, beam level mobility may only be performed based on a CSI reference signal (“RS”) (“CSI-RS”).

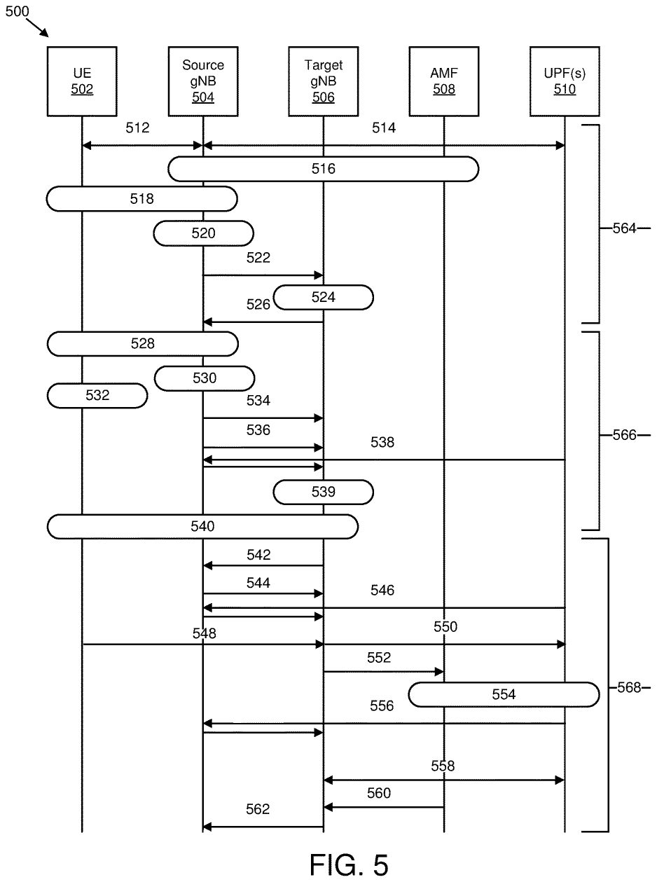

In certain embodiments, there may be HO procedures. In some embodiments, there may be C-Plane handling. In such embodiments, the intra-NR radio access network (“RAN”) HO performs the preparation and execution phase of a HO procedure performed without involvement of a fifth generation cell (“5GC”) (e.g., preparation messages are directly exchanged between the gNBs). The release of resources at a source gNB during a HO completion phase is triggered by a target gNB. FIG. 5 depicts the basic HO scenario where neither an AMF nor a UPF changes.

FIG. 5 is a schematic block diagram illustrating one embodiment of a system 500 for intra-AMF and/or UPF HO. The system 500 includes a UE 502, a source gNB 504, a target gNB 506, an AMF 508, and a UPF 510 (e.g., one or more UPFs). Each of the communications in the system 500 may include one or more messages.

In a first communication 512 and a second communication 514, user data may be communicated.

In a third communication 516, the UE 502 context within the source gNB 504 contains information regarding roaming and access restrictions which were provided either at connection establishment or at a last timing advance (“TA”) update.

In a fourth communication 518, the source gNB 504 configures the UE 502 measurement procedures and the UE 502 reports according to the measurement configuration.

The source gNB 504 decides 520 to HO the UE 502 based on a MeasurementReport and radio resource management (“RRM”) information.

In a fifth communication 522, the source gNB 504 issues a HO request message to the target gNB 506 passing a transparent RRC container with necessary information to prepare the HO at the target side. The information includes at least the target cell ID, KgNB*, the cell radio network temporary identifier (“C-RNTI”) of the UE 502 in the source gNB, RRM-configuration including UE inactive time, basic AS-configuration including antenna info and DL carrier frequency, the current quality of service (“QoS”) flow to DRB mapping rules applied to the UE 502, the system information block 1 (“SIB1”) from source gNB, the UE 502 capabilities for different RATs, PDU session related information, and may include the UE reported measurement information including beam-related information if available. The PDU session related information includes the slice information and QoS flow level QoS profiles. The source gNB 504 may also request a DAPS HO for one or more DRBs. After issuing a HO request, the source gNB 504 should not reconfigure the UE 502, including performing reflective QoS flow to DRB mapping.

Admission control may be performed 524 by the target gNB 506. Slice-aware admission control may be performed if the slice information is sent to the target gNB 506. If the PDU sessions are associated with non-supported slices, the target gNB 506 may reject such PDU sessions.

In a sixth communication 526, the target gNB 506 prepares the HO with L1 and/or L2 and sends the HANDOVER REQUEST ACKNOWLEDGE to the source gNB 504, which includes a transparent container to be sent to the UE 502 as an RRC message to perform the HO. The target gNB 506 also indicates if a DAPS HO is accepted. As soon as the source gNB 504 receives the HANDOVER REQUEST ACKNOWLEDGE, or as soon as the transmission of the HO command is initiated in the downlink, data forwarding may be initiated. For DRBs configured with DAPS, downlink PDCP SDUs are forwarded with a sequence number (“SN”) assigned by the source gNB 504, until SN assignment is handed over to the target gNB 506, for which the normal data forwarding follows.

In a seventh communication 528, the source gNB 504 triggers the Uu HO by sending an RRCReconfiguration message to the UE 502 containing the information required to access the target cell: at least the target cell ID, the new C-RNTI, the target gNB 506 security algorithm identifiers for the selected security algorithms. It can also include a set of dedicated random access channel (“RACH”) resources, the association between RACH resources and SSBs, the association between RACH resources and UE-specific CSI-RS configurations, common RACH resources, and system information of the target cell. For DRBs configured with DAPS, the source gNB 504 does not stop transmitting downlink packets until it receives the HANDOVER SUCCESS message from the target gNB 506. CHO cannot be configured simultaneously with DAPS HO. The source gNB 504 may deliver 530 buffered data and new data from UPFs. Moreover, the UE 502 may detach 532 from an old cell and synchronize to a new cell.

In an eight communication 534, for DRBs configured with DAPS, the source gNB 504 sends an EARLY STATUS TRANSFER message. The DL COUNT value conveyed in the EARLY STATUS TRANSFER message indicates PDCP SN and hyper frame number (“HFN”) of the first PDCP SDU that the source gNB 504 forwards to the target gNB 506. The source gNB 504 does not stop assigning SNs to downlink PDCP SDUs until it sends the SN STATUS TRANSFER message to the target gNB 506.

In a nineth communication 536, for DRBs not configured with DAPS, the source gNB 504 sends the SN STATUS TRANSFER message to the target gNB 506 to convey the uplink PDCP SN receiver status and the downlink PDCP SN transmitter status of DRBs for which PDCP status preservation applies (e.g., for RLC acknowledge mode (“AM”)). The uplink PDCP SN receiver status includes at least the PDCP SN of the first missing UL PDCP SDU and may include a bit map of the receive status of the out of sequence UL PDCP SDUs that the UE 502 needs to retransmit in the target cell, if any. The downlink PDCP SN transmitter status indicates the next PDCP SN that the target gNB 506 may assign to new PDCP SDUs, not having a PDCP SN yet. In case of DAPS HO, the uplink PDCP SN receiver status and the downlink PDCP SN transmitter status for a DRB with RLC AM (“RLC-AM”) and not configured with DAPS may be transferred by the SN STATUS TRANSFER message. For DRBs configured with DAPS, the source gNB may additionally send the EARLY STATUS TRANSFER messages to inform discarding of already forwarded PDCP SDUs. The target gNB 506 does not transmit forwarded downlink PDCP SDUs to the UE 502, whose COUNT is less than the conveyed DL COUNT value and discards them if transmission has not been attempted already.

In a tenth communication 538, user data may be communicated. Moreover, the target gNB 506 may buffer 539 the user data from the source gNB 504.

In an eleventh communication 540, the UE 502 synchronizes to the target cell and completes the RRC HO procedure by sending an RRCReconfigurationComplete message to the target gNB 506. In case of DAPS HO, the UE 502 does not detach from the source cell upon receiving the RRCReconfiguration message. The UE 502 releases the source resources and configurations and stops DL and/or UL reception and/or transmission with the source upon receiving an explicit release from the target node. From RAN point of view, the DAPS HO is considered to only be completed after the UE 502 has released the source cell as explicitly requested from the target node. For RRC suspend, a subsequent HO or inter-RAT HO cannot be initiated until the source cell has been released.

In a twelfth communication 542 and/or a thirteenth communication 544, in case of DAPS HO, the target gNB 506 sends a HANDOVER SUCCESS message to the source gNB 504 to inform that the UE 502 has successfully accessed the target cell. In return, the source gNB 504 sends the SN STATUS TRANSFER message for DRBs configured with DAPS, and the normal data forwarding follows. The uplink PDCP SN receiver status and the downlink PDCP SN transmitter status are also conveyed for DRBs with RLC unacknowledged mode (“UM”) (“RLC-UM”) in the SN STATUS TRANSFER message, if configured with DAPS.

For DRBs configured with DAPS, the source gNB 504 does not stop delivering uplink QOS flows to the UPF until it sends the SN STATUS TRANSFER message in step 8b. The target gNB does not forward QoS flows of the uplink PDCP SDUs successfully received in-sequence to the UPF 510 until it receives the SN STATUS TRANSFER message, in which UL HFN and the first missing SN in the uplink PDCP SN receiver status indicates the start of uplink PDCP SDUs to be delivered to the UPF 510. The target gNB 506 does not deliver any uplink PDCP SDUs which has an UL COUNT lower than the provided.

In a fourteenth communication 546, a fifteenth communication 548, and a sixteenth communication 550, user data is transmitted.

In a seventeenth communication 552, the target gNB 506 sends a PATH SWITCH REQUEST message to the AMF 508 to trigger the 5GC to switch the DL data path towards the target gNB 506 and to establish an (“NG-C”) interface instance towards the target gNB 506.

In an eighteenth communication 554, 5GC switches the DL data path towards the target gNB 506. In a nineteenth communication 556, the UPF 510 sends one or more “end marker” packets on the old path to the source gNB 504 per PDU session and/or tunnel and then can release any user plane (“U-plane”) and/or transport network layer (“TNL”) resources towards the source gNB 502.

In a twentieth communication 558, user data may be communicated.

In a twenty-first communication 560, the AMF 508 confirms the PATH SWITCH REQUEST message with a PATH SWITCH REQUEST ACKNOWLEDGE message.

Upon reception of the PATH SWITCH REQUEST ACKNOWLEDGE message from the AMF 508, in a twenty-second communication 562, the target gNB 506 sends a UE CONTEXT RELEASE to inform the source gNB 504 about the success of the HO. The source gNB 504 can then release radio and C-plane related resources associated with the UE context. Any ongoing data forwarding may continue. In the system 500 of FIG. 5, some steps 564 may correspond to HO preparation, certain steps 566 may correspond to HO execution, and other steps 568 may correspond to HO completion.

The RRM configuration may include both beam measurement information (e.g., for L3 mobility) associated with SSBs and CSI-RSs for the reported cells if both types of measurements are available. Also, if CA is configured, the RRM configuration may include the list of best cells on each frequency for which measurement information is available, and the RRM measurement information can also include the beam measurement for the listed cells that belong to the target gNB.

The common RACH configuration for beams in the target cell is only associated with the SSBs. The network can have dedicated RACH configurations associated with the SSBs and/or have dedicated RACH configurations associated with CSI-RSs within a cell. The target gNB can only include one of the following RACH configurations in the HO command to enable the UE to access the target cell: 1) common RACH configuration; 2) common RACH configuration+dedicated RACH configuration associated with SSB; and 3) common RACH configuration+dedicated RACH configuration associated with CSI-RS.

The dedicated RACH configuration allocates RACH resources together with a quality threshold to use them. When dedicated RACH resources are provided, they are prioritized by the UE and the UE may not switch to contention-based RACH resources as long as the quality threshold of those dedicated resources is met. The order to access the dedicated RACH resources is up to UE implementation.

Upon receiving a HO command requesting DAPS HO, the UE suspends source cell SRBs, stops sending and receiving any RRC control plane signaling toward the source cell, and establishes SRBs for the target cell. The UE releases the source cell SRBs configuration upon receiving source cell release indication from the target cell after successful DAPS HO execution. When DAPS HO to the target cell fails and, if the source cell link is available, then the UE reverts back to the source cell configuration and resumes source cell SRBs for control plane signaling transmission.

In some embodiments, there may be enhanced mobility with objectives to specify mechanism and procedures of L1 and/or L2 based inter-cell mobility for mobility latency reduction that may include: 1) configuration and maintenance for multiple candidate cells to allow fast application of configurations for candidate cells; 2) dynamic switch mechanism among candidate serving cells (e.g., including SpCell and secondary cell (“SCell”)) for the potential applicable scenarios based on L1 and/or L2 signaling; 3) L1 enhancements for inter-cell beam management, including LI measurement and reporting, and beam indication; 4) TA management; and/or 5) centralized unit-distributed unit (“CU-DU”) interface signaling to support L1 and/or L2 mobility. It should be noted that FR2 specific enhancements are not precluded, and that the procedure of L1 and/or L2 based inter-cell mobility may be applicable to the following scenarios: 1) standalone, CA, and NR-DC with a serving cell change within one configured grant (“CG”); 2) intra-DU and intra-CU inter-DU (e.g., applicable for standalone and CA: no new RAN interfaces are expected); 3) both intra-frequency and inter-frequency; 4) both FR1 and FR2; and/or 5) source and target cells may be synchronized or non-synchronized.

In various embodiments, to specify mechanism and procedures of NR-DC with selective activation of the cell groups (e.g., at least for SCG) via L3 enhancements, there may be procedures to allow subsequent cell group change after changing CG without reconfiguration and re-initiation of CPC and/or CPA. Certain embodiments may be used to specify data forwarding optimizations for CHO including target MCG and target SCG in NR-DC.

Some embodiments may be used to specify CHO including target MCG and candidate SCGs for CPC/CPA in NR-DC. In such embodiments, CHO including target MCG and target SCG may be used as a baseline.

If a UE would be provided with full configuration for each possible candidate cell, including not only the SpCells but also their adjoining SCells, configurations including radio bearer configuration, lower layer configuration, measurement configuration, and so forth for every likely scenario in which the UE might find itself in, the processing load on the UE will increase together with: 1) battery consumption (e.g., in trying to detect and measure cell configuration that are not yet in the UE's coverage range or are of very weak radio geometry); and 2) the signaling overhead and this will negatively affect the mobility latency and may also worsen data interruption during mobility leading to bad user experience.

Described embodiments herein may correspond to signaling overhead and reduce a processing and measurement burden on a UE to facilitate enhancing mobility.

In various embodiments, if a UE would be provided a full configuration for each possible candidate cell, including not only the SpCells (e.g., PCell or PSCell) but also their adjoining SCells, the full configurations including radio bearer configuration, lower layer configuration, measurement configuration, and so forth for every likely scenario in which the UE might find itself in, the processing load on the UE will increase together with the signaling overhead and this will negatively affect the mobility latency and may also worsen data interruption leading to bad user experience.

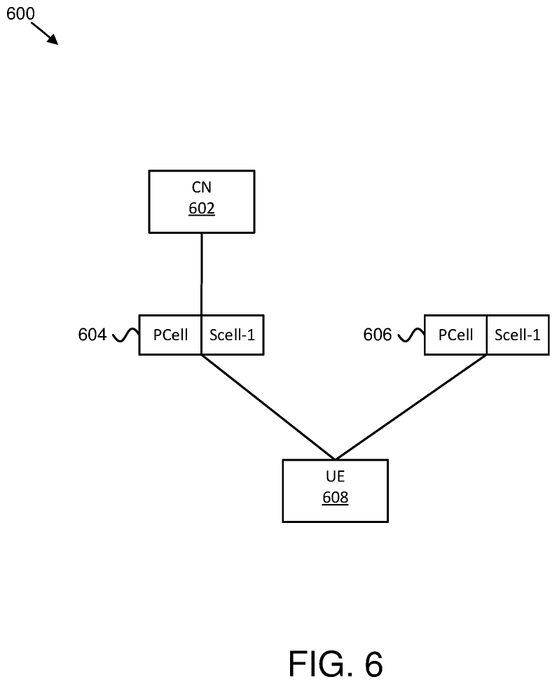

In some embodiments, one 5G NR cell can provide a standalone coverage to a UE and, in this case, only one cell is used to provide coverage to the UE. However, there are at least the following two modes to improve the data throughput to the UE and/or balance the radio interface load of a cell: 1) carrier aggregation (“CA”) in which two or more component carriers (“CCs”) are aggregated—a UE may simultaneously receive or transmit on one or more CCs depending on its capabilities—one CC can be one NR cell; and 2) dual connectivity using 5G NR cells only: NG-RAN supports new-radio dual connectivity (“NR-DC”) operation whereby a UE in RRC_CONNECTED is configured to use radio resources provided by two distinct schedulers located in two different NR nodes, both providing NR access as shown in FIG. 6. The first node is called a master node (“MN”) and together with one or more cells (e.g., SCells) from the MN, along with the PCell, this first cell group is called a master cell group (“MCG”). A second node added by the MN to the UE is called a secondary node (“SN”). Together with one or more cells (e.g., SCells) from the SN and with the PSCell, this second cell group is called a secondary cell group (“SCG”). When the UE is configured with SCG, the UE is configured with two MAC entities: one MAC entity for the MCG and one MAC entity for the SCG.

FIG. 6 is a block diagram illustrating one embodiment of a system 600 having dual connectivity. The system 600 includes a core network (“CN”) 602, a MCG/MN 604, an SCG/SN 606, and a UE 608 showing dual connectivity for the UE 608.

In some embodiments, the following definitions may apply: 1) en-gNB: node providing NR user plane and control plane protocol terminations towards the UE, and acting as a SN in EN-DC; 2) MCG: in MR-DC, a group of serving cells associated with the MN comprising of the SpCell (e.g., PCell) and optionally one or more SCells; 3) MN: in MR-DC, the radio access node that provides the control plane connection to the core network—it may be a master eNB (e.g., in EN-DC), a master ng-eNB (e.g., in NGEN-DC) or a master gNB (e.g., in NR-DC and NE-DC); 4) MCG bearer: in MR-DC, a radio bearer with an RLC bearer (or two RLC bearers in case of CA packet duplication) only in the MCG; 5) MN terminated bearer: in MR-DC a radio bearer for which PDCP is located in the MN; 6) MCG SRB: in MR-DC, a direct signaling radio bearer (“SRB”) between the MN and the UE; 7) multi-radio dual connectivity: dual connectivity between evolved (“E”) universal terrestrial radio access (“UTRA”) (“E-UTRA”) and NR nodes, or between two NR nodes; 8) Ng-eNB: as defined in 3GPP; 9) PCell: SpCell of a master cell group; 10) PSCell: SpCell of a secondary cell group; 11) RLC bearer: RLC and MAC logical channel configuration of a radio bearer in one cell group; 12) secondary cell group: in MR-DC, a group of serving cells associated with the SN including the SpCell (e.g., PSCell) and optionally one or more SCells; 13) secondary node: in MR-DC, the radio access node, with no control plane connection to the core network, providing additional resources to the UE—it may be an en-gNB (e.g., in EN-DC), a secondary ng-eNB (e.g., in NE-DC) or a secondary gNB (e.g., in NR-DC and NGEN-DC); 14) SCG bearer: in MR-DC, a radio bearer with an RLC bearer (or two RLC bearers in case of CA packet duplication) only in the SCG; 15) SN terminated bearer: in MR-DC, a radio bearer for which PDCP is located in the SN; 16) SpCell: primary cell of a master or secondary cell group; 17) SRB3: in EN-DC, NGEN-DC and NR-DC, a direct SRB between the SN and the UE; and 18) split bearer: in MR-DC, a radio bearer with RLC bearers both in MCG and SCG.

In various embodiments, mobility includes that a mobility procedure, possible executed in the lower layers (e.g., L1 and/or L2) can change the PCell/MCG (e.g., including one or more SCells from the MN) of the UE as well as also the PSCell/SCG (e.g., including one or more SCells from the SN) of the UE. A RRCReconfiguration message is used to perform an MCG and/or SCG change for a legacy UE. The RRCReconfiguration message is the command to modify an RRC connection. It may convey information for measurement configuration, mobility control, radio resource configuration (e.g., including RBs, MAC main configuration, and physical channel configuration) and AS security configuration. The UE receives an RRC Reconfiguration message from the gNB which may contain among others, the following information elements (“IEs”): 1) configuration for MCG “MasterCellGroup”; 2) configuration for SCG “SecondaryCellGroup”; and 3) configuration to execute mobility based on certain conditions, called “ConditionalReconfiguration”, where the conditions are one or more measurement events, configured as a measurement identity (“MeasId”). The ConditionalReconfiguration in turn may contain configuration applicable for a target cell after mobility to this target is considered successful according to one or more (e.g., up to 8) RRCReconfiguration that may be contained inside the ConditionalReconfiguration providing UE configuration for future (e.g., candidate) master and secondary cell groups.

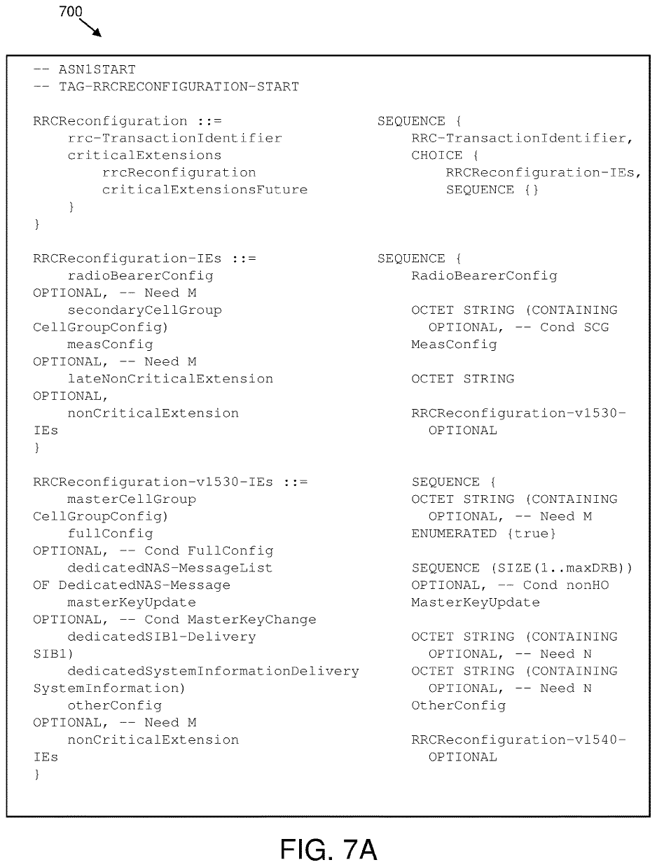

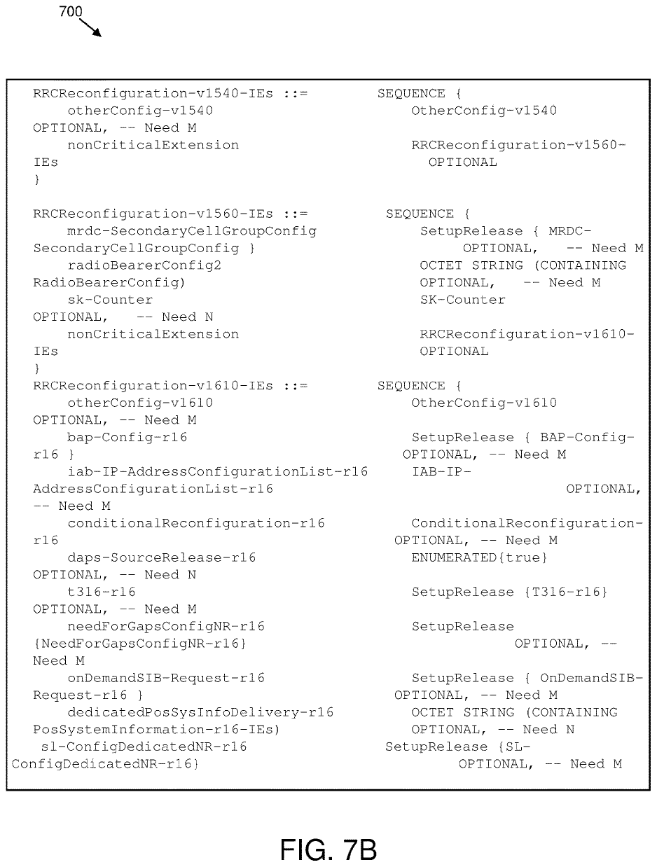

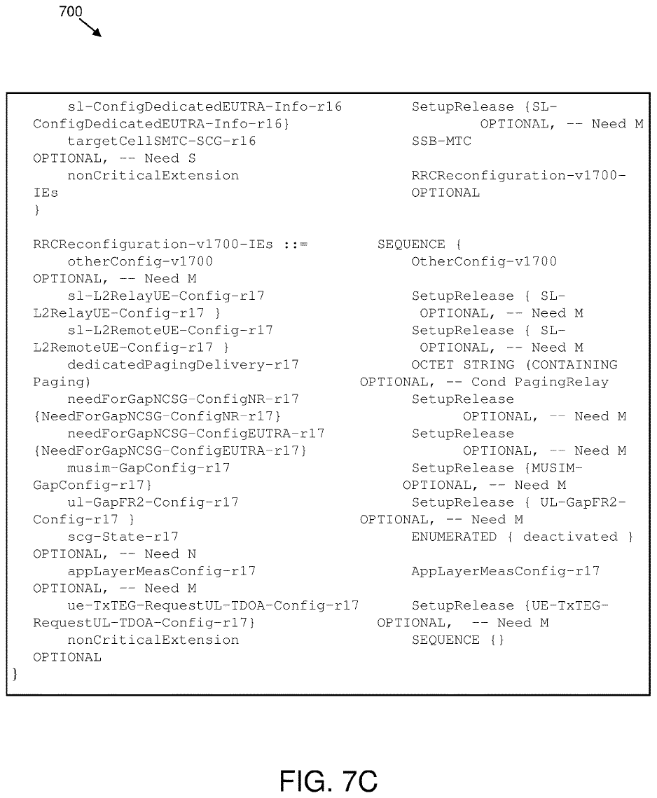

FIGS. 7A through 7C are diagram illustrating one embodiment of code 700 for an RRC reconfiguration message.

In a first embodiment, multiple RRCReconfiguration are provided to a UE, each potentially comprising: 1) one CA configuration (e.g., target PCell with zero or more SCells) and/or NR-DC configuration (e.g., one target PCell, one target PSCell with zero or more SCells); or 2) one MCG configuration and/or one SCG configuration.

In various embodiments, linking of RRCReconfiguration is signaled such that after a successful mobility to one candidate, a UE activates measurement for only the linked RRCReconfigurations. The remaining RRCReconfigurations are kept (e.g., not used until there is further mobility success).

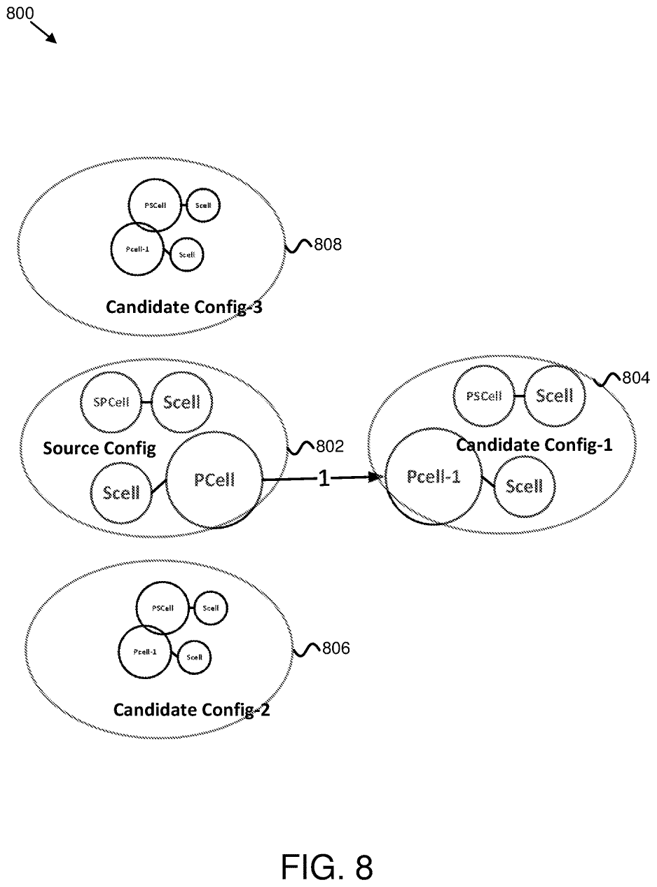

FIG. 8 is a schematic block diagram illustrating one embodiment of a system 800 showing three candidate configurations provided to a UE. The system 800 includes a source config 802, a candidate config-1 804, a candidate config-2 806, and a candidate config-3 808. The UE may move from the source config 802 to the candidate config-1 804.

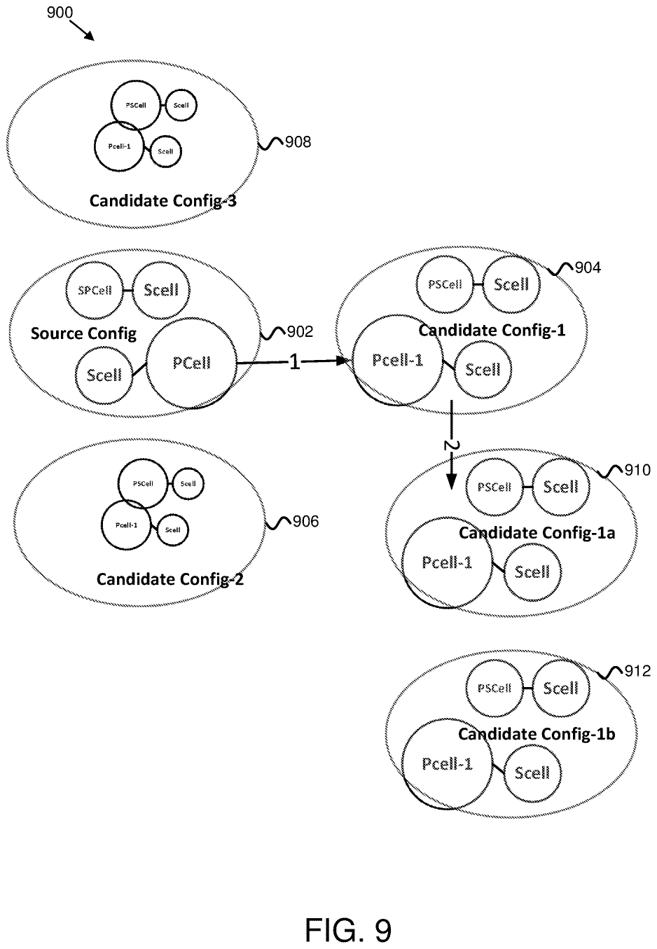

In FIG. 8, there are multiple configurations provided together with their link to the source configuration such that while being on source configuration, the UE measures (e.g., corresponding measurement identities are considered active) candidate configurations 1, 2, and 3 but not any further configurations, as illustrated in FIG. 9.

FIG. 9 is a schematic block diagram illustrating one embodiment of a system 900 showing candidate configuration activation. The system 900 includes a source config 902, a candidate config-1 904, a candidate config-2 906, a candidate config-3 908, a candidate config-la 910, and a candidate config-1b 912.

As in the FIG. 9, successful mobility to the candidate config-1 904 from the source configuration activates the candidate config-1a 910 and the candidate config-1b 912. The linking between the configurations is provided using an RRC reconfiguration message. The linking may be provided explicitly using a same group number being provided to all configurations for which measurements need to be activated once the UE performs a successful mobility to one of them. Alternatively, the linking may be provided explicitly by allocating a configuration index to each configuration and indicating one or more configuration identifiers (“IDs”) linked to ‘this’ configuration.

In certain embodiments, multiple CellGroupConfiguration are provided to a UE, each potentially including: 1) a singlecandidate MCG configuration; or 2) a single candidate SCG configuration.

In some embodiments, linking of CellGroupConfiguration is signaled such that after a successful mobility to one candidate, a UE activates measurement for only the linked CellGroupConfigurations. The remaining CellGroupConfigurations are kept (e.g., not used until further successful mobility). Linking can be signaled as described in other embodiments.

In various embodiments, multiple SpCellConfig are provided to a UE, each potentially including: 1) single candidate PCell configuration; or 2) single candidate PSCell configuration.

In certain embodiments, linking of SpCellConfig is signaled such that after a successful mobility to one candidate, a UE activates measurement for only the linked SpCellConfigs. The remaining SpCellConfigs are kept (e.g., not used until further successful mobility). Linking may be signaled as described in other embodiments.

In some embodiments, there may be MAC based activation of configuration in which every configuration (e.g., RRCReconfiguration, CellGroupConfiguration, or SpCellConfig) is indexed. After a successful mobility, a gNB sends a MAC control element (“CE”) activating a subset of configuration. This may use a BITMAP where each bit of the BITMAP corresponds to the candidate configuration. In such a bitmap, a first bit corresponds to the first configuration, a second bit corresponds to the second configuration, and so forth.

In various embodiments, multiple measurement identities are provided to a UE, and these are linked such that after a successful mobility to a candidate and/or target configuration to a SPCell, the UE activates only measurement identities linked to an original measurement identity. To determine the original measurement identity, the UE traces back measurement objects where the SPCell is located (e.g., in the measurement objects containing the same NR frequency as that of the SPCell's). Then the UE determines the measurement identity that is associated with the measurement object. While tracing, the UE may consider a list of ‘exclude-listed’ cells and a list of ‘allow-listed’ cells, if listed in configured measurement object. Exclude-listed cells are not applicable in event evaluation or measurement reporting. Allow-listed cells are the only ones applicable in event evaluation or measurement reporting.

In certain embodiments, a measurement configuration includes measurement object, reporting configurations, measurement identities, quantity configurations, and/or measurement gaps.

In some embodiments, measurement objects include a list of objects on which a UE may perform measurements: 1) for intra-frequency and inter-frequency measurements a measurement object indicates the frequency and/or time location and subcarrier spacing of reference signals to be measured—associated with this measurement object, the network may configure a list of cell specific offsets, a list of ‘exclude-listed’ cells and a list of ‘allow-listed’ cells—exclude-listed cells are not applicable in event evaluation or measurement reporting—allow-listed cells are the only ones applicable in event evaluation or measurement reporting; 2) the measObjectId of the mobile originating (“MO”) which corresponds to each serving cell is indicated by serving CellMO within the serving cell configuration; 3) for inter-RAT E-UTRA measurements, a measurement object is a single E-UTRA carrier frequency—associated with this E-UTRA carrier frequency, the network can configure a list of cell specific offsets and a list of ‘exclude-listed’ cells—exclude-listed cells are not applicable in event evaluation or measurement reporting; 4) for inter-RAT UTRA frequency division duplexing (“FDD”) (“UTRA-FDD”) measurements a measurement object is a set of cells on a single UTRA-FDD carrier frequency; 5) for NR sidelink measurements of L2 UE to network (“U2N”) relay UEs, a measurement object is a single NR sidelink frequency to be measured; 6) for channel busy ratio (“CBR”) measurement of NR sidelink communication, a measurement object is a set of transmission resource pools on a single carrier frequency for NR sidelink communication; 7) for CBR measurement of NR sidelink discovery, a measurement object is a set of discovery dedicated resource pools or transmission resource pools also used for NR sidelink discovery on a single carrier frequency for NR sidelink discovery; and 8) for cross-link interference (“CLI”) measurements, a measurement object indicates the frequency and/or time location of sounding reference signal (“SRS”) resources and/or CLI-RSSI resources, and subcarrier spacing of SRS resources to be measured.

In various embodiments, for reporting configurations—a list of reporting configurations where there can be one or more reporting configurations per measurement object—each measurement reporting configuration includes the following: 1) reporting criterion: the criterion that triggers the UE to send a measurement report—this can either be periodical or a single event description; 2) RS type: the RS that the UE uses for beam and cell measurement results (e.g., synchronization signal (“SS”) and/or physical broadcast channel (“PBCH”) (“SS/PBCH”) block or CSI-RS); and 3) reporting format: the quantities per cell and per beam that the UE includes in the measurement report (e.g., reference signal received power (“RSRP”)) and other associated information such as the maximum number of cells and the maximum number beams per cell to report.

In case of conditional reconfiguration, each configuration includes the following: 1) execution criteria: the criteria a UE uses for conditional reconfiguration execution; and 2) RS type: the RS that the UE uses for obtaining beam and cell measurement results (e.g., SS/PBCH block-based or CSI-RS-based) used for evaluating conditional reconfiguration execution condition.

In certain embodiments there may be measurement identities. For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration, and up to 2 measurement identities can be linked to one conditional reconfiguration execution condition.

In some embodiments there may be quantity configurations. The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients may be configured for different measurement quantities, for different RS types, and for measurements per cell and per beam.

In various embodiments, there may be measurement gaps including periods that the UE may use to perform measurements.

In certain embodiments, a UE in RRC_CONNECTED maintains a measurement object list, a reporting configuration list, and a measurement identities list according to signaling and procedures found herein. The measurement object list possibly includes NR measurement objects, CLI measurement objects, inter-RAT objects, and L2 U2N relay objects. Similarly, the reporting configuration list includes NR, inter-RAT, and L2 U2N relay reporting configurations. Any measurement object may be linked to any reporting configuration of the same RAT type. Some reporting configurations may not be linked to a measurement object. Likewise, some measurement objects may not be linked to a reporting configuration.

In some embodiments, the measurement procedures distinguish the following types of cells: 1) the NR serving cells—these are the SpCell and one or more SCells; 2) listed cells—these are cells listed within the measurement objects; 3) detected cells—these are cells that are not listed within the measurement objects but are detected by the UE on the SSB frequencies and subcarrier spacings indicated by the measurement objects; 4) MAC based activation of measurement identities: after a successful mobility, a gNB sends a MAC CE activating a subset of measurement identities; 5) for NR-DC, the UE may receive two independent measConfig: a) a measConfig, associated with MCG, that is included in the RRCReconfiguration message received via SRB1, and b) a measConfig, associated with SCG, that is included in the RRCReconfiguration message received via SRB3, or, alternatively, included within a RRCReconfiguration message embedded in a RRCReconfiguration message received via SRB1—a measConfig may be associated with each configuration (e.g., RRCReconfiguration, CellGroupConfiguration, or SpCellConfig)—using any of the linking methods disclosed previously, a subset of the configured measConfig will be considered activated; 6) a concept of first active configuration is revealed whereby the network may explicitly indicate to the UE which of all candidate configurations are considered as immediately active—alternatively, a network can configure a number of measurement identities and let the UE know which measurement identities are to be considered immediately active—a subset of the remaining measurement identities will be activated based on successful mobility to one of the candidate configurations according to the linking information described previously; and 7) concept for signaling optimization is revealed. Herein the concept of delta signaling is used such that configuration corresponding to a candidate configuration is provided only on a delta basis (e.g., only values for only these IEs are signaled to the UE), that have different value compared with a baseline configuration. Two possible alternatives may be used: 1) using the link-start configuration as the baseline for applying delta configuration towards the link-end configuration; and 2) using the source configuration in the source node as the baseline for applying delta configuration. The source node is the node that sent the RRC reconfiguration to the UE containing one or more candidate configurations and the source configuration is the configuration.

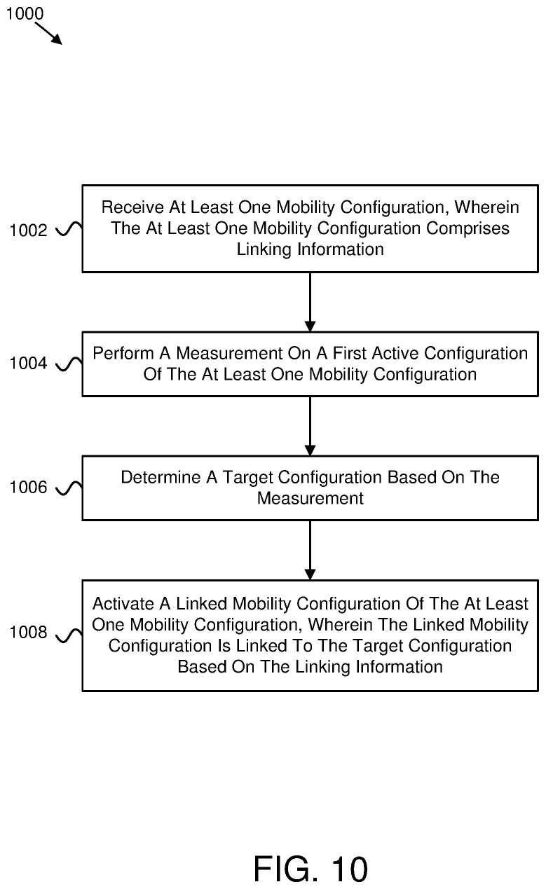

FIG. 10 is a flow chart diagram illustrating another embodiment of a method 1000 for configuring linking between mobility configurations. In some embodiments, the method 1000 is performed by an apparatus, such as the remote unit 102. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes receiving 1002 at least one mobility configuration. The at least one mobility configuration includes linking information. In some embodiments, the method 1000 includes performing 1004 a measurement on a first active configuration of the at least one mobility configuration. In certain embodiments, the method 1000 includes determining 1006 a target configuration based on the measurement. In various embodiments, the method 1000 includes activating 1008 a linked mobility configuration of the at least one mobility configuration. The linked mobility configuration is linked to the target configuration based on the linking information.

In certain embodiments, the at least one mobility configuration comprises an RRCReconfiguration, a CellGroupConfig, a SPCellConfig, measurement identities, a measurement configuration, or a combination thereof. In some embodiments, the mobility check is executed in a lower layer of the UE, and the lower layer comprises a MAC, a physical layer, or a combination thereof.

In one embodiment, an apparatus for wireless communication, the apparatus comprises: a processor; and a memory coupled to the processor, the processor configured to cause the apparatus to: receive at least one mobility configuration, wherein the at least one mobility configuration comprises linking information; perform a measurement on a first active configuration of the at least one mobility configuration; determine a target configuration based on the measurement; and activate a linked mobility configuration of the at least one mobility configuration, wherein the linked mobility configuration is linked to the target configuration based on the linking information.

In certain embodiments, the at least one mobility configuration comprises an RRCReconfiguration, a CellGroupConfig, a SPCellConfig, measurement identities, a measurement configuration, or a combination thereof.

In some embodiments, the mobility check is executed in a lower layer of the UE, and the lower layer comprises a MAC, a physical layer, or a combination thereof.

In one embodiment, a method at a UE, the method comprises: receiving at least one mobility configuration, wherein the at least one mobility configuration comprises linking information; performing a measurement on a first active configuration of the at least one mobility configuration; determining a target configuration based on the measurement; and activating a linked mobility configuration of the at least one mobility configuration, wherein the linked mobility configuration is linked to the target configuration based on the linking information.

In certain embodiments, the at least one mobility configuration comprises an RRCReconfiguration, a CellGroupConfig, a SPCellConfig, measurement identities, a measurement configuration, or a combination thereof.

In some embodiments, the mobility check is executed in a lower layer of the UE, and the lower layer comprises a MAC, a physical layer, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a set of mobility configurations, wherein the at least one comprising linking information;
perform a measurement on a first active configuration of a first mobility configuration of the set of mobility configurations;
determine a target configuration based on the measurement; and
activate a second mobility configuration of the at least one-set of mobility configurations, wherein the second mobility configuration is linked to the target configuration based on the linking information.

2. The UE of claim 1, wherein the set of mobility configurations comprises a radio resource control (RRC) reconfiguration, a cell group configuration, a serving primary cell configuration, a measurement identifier, or a measurement configuration, or a combination thereof.

3. The UE of claim 1, wherein the at least one processor is further configured to cause the UE to perform a mobility check at a lower layer of the UE, and wherein the lower layer comprises a medium access control (MAC) layer, or a physical (PHY) layer, or a combination thereof.

4. A processor for wireless communication, comprising:
at least one controller coupled with at least one memory and configured to cause the processor to:
receive a set of mobility configurations comprising linking information;
perform a measurement on a first active configuration of a first mobility configuration of the set of mobility configurations;
determine a target configuration based on the measurement; and
activate a second mobility configuration of the set of mobility configurations, wherein the second mobility configuration is linked to the target configuration based on the linking information.

5. The processor of claim 4, wherein the set of mobility configurations comprises a radio resource control (RRC) reconfiguration, a cell group configuration, a serving primary cell configuration, a measurement identifier, or a measurement configuration, or a combination thereof.

6. The processor of claim 4, wherein the at least one controller is further configured to cause the processor to perform a mobility check at a lower layer of a user equipment (UE), and wherein the lower layer comprises a medium access control (MAC) layer, or a physical (PHY) layer, or a combination thereof.

7. A method performed by a user equipment (UE), the method comprising:
receiving a set of mobility configurations comprising linking information;
performing a measurement on a first active configuration of a first mobility configuration of the set of mobility configurations;
determining a target configuration based on the measurement; and
activating a second mobility configuration of the set of mobility configurations, wherein the second mobility configuration is linked to the target configuration based on the linking information.

8. The method of claim 7, wherein the set of mobility configurations comprises a radio resource control (RRC) reconfiguration, a cell group configuration, a serving primary cell configuration, a measurement identifier, or a measurement configuration, or a combination thereof.

9. The method of claim 7, further comprising performing a mobility check at a lower layer of the UE, and wherein the lower layer comprises a medium access control (MAC) layer, or a physical (PHY) layer, or a combination thereof.

10. A base station, comprising:
at least one memory; and
at least one processor coupled with the at least one memory and configured to cause the base station to:
receive a set of mobility configurations comprising linking information;
perform a measurement on a first active configuration of a first mobility configuration of the set of mobility configurations;
determine a target configuration based on the measurement; and
activate a second mobility configuration of the set of mobility configurations, wherein the second mobility configuration is linked to the target configuration based on the linking information.

11. The base station of claim 10, wherein the set of mobility configurations comprises a radio resource control (RRC) reconfiguration, a cell group configuration, a serving primary cell configuration, a measurement identifier, or a measurement configuration, or a combination thereof.

12. The base station of claim 10, wherein the at least one processor is further configured to cause the base station to perform a mobility check at a lower layer of a user equipment (UE), and wherein the lower layer comprises a medium access control (MAC) layer, or a physical (PHY) layer, or a combination thereof.

13. The UE of claim 1, wherein the at least one processor is configured to cause the UE to receive an indication of the first active configuration from a base station.

14. The UE of claim 1, wherein the measurement is selected from a plurality of measurement identities.

15. The processor of claim 4, wherein the at least one controller is configured to cause the processor to receive an indication of the first active configuration from a base station.

16. The processor of claim 4, wherein the measurement is selected from a plurality of measurement identities.

17. The method of claim 7, further comprising receiving an indication of the first active configuration from a base station.

18. The method of claim 7, wherein the measurement is selected from a plurality of measurement identities.

19. The base station of claim 10, wherein the at least one processor is configured to cause the base station to transmit an indication of the first active configuration to a user equipment (UE).

20. The base station of claim 10, wherein the measurement is selected from a plurality of measurement identities.
